(19) United States
(12) Patent Application Publication
(10) Pub. No.: US 2019/0279622 A1
(43) Pub. Date: Sep. 12, 2019

(54) METHOD FOR SPEECH RECOGNITION DICTATION AND CORRECTION, AND SYSTEM

(71) Applicant: KIKA TECH (CAYMAN) HOLDINGS CO., LIMITED, Beijing (CN)

(72) Inventors: Yu LIU, Beijing (CN); Conglei YAO, Beijing (CN); Hao CHEN, Beijing (CN); Chengzhi LI, Beijing (CN); Jingchen SHU, Beijing (CN)

(21) Appl. No.: 15/915,687

(22) Filed: Mar. 8, 2018

(51) Int. Cl. G10L 15/22; G10L 15/18; G10L 15/30

(52) U.S. Cl. CPC G10L 15/22; G10L 2015/088; G10L 15/30; G10L 15/18

(57) ABSTRACT

A method for speech recognition dictation and correction, and a related system are provided. The disclosed method is implemented in a system including a terminal and a server, which includes transforming a speech signal received by the terminal into a speech recognition result. A speech setting is determined according to the speech recognition result. In response to an explicit command setting in which the speech recognition result contains a trigger word, the speech recognition result is decomposed into the trigger word and a command. A first speech recognition result is modified to form an edited speech recognition input according to the command. The edited speech recognition input is displayed on a user interface of the terminal. Accordingly, the speech recognition correction is achieved by speech interaction.

### FIELD OF THE DISCLOSURE

The present disclosure relates to the field of speech recognition technologies and, more particularly, relates to a method for speech recognition dictation and correction, and a system implementing the above-identified method.

### BACKGROUND

With the development of speech recognition related technology, more and more electronic devices are equipped with speech recognition applications to establish another channel of interaction between human and electronic devices.

Regarding speech recognition applications of mobile devices, some provide input units with built-in speech-to-text transforming functions. The auxiliary transforming functions facilitate a user to obtain texts from speech inputs. And some provide smart speech assistant functions, with which voices of the user are transformed into control instructions to perform specific functions on electronic devices, such as searching a nearby restaurant, setting up an alarm clock, playing music, and the like.

However, due to the limitation of speech recognition accuracy, sometimes the user is still required to manually correct a speech recognition result with errors. Accordingly, input efficiency is dramatically reduced. To make it worse, when a user interface is unreachable, or when the electronic device is without a touch user interface, the user may experience more confusions and inconvenience.

Some speech recognition applications make a correction by applying preset templates. By means of the provided templates, the user can obtain speech recognition correction by the operations of insertion, selection, deletion, replacement and the like. However, the corrections are only performed in response to the templates. That is, only when the user accurately gives one of the templated instructions, can an action be taken to correct errors. Furthermore, speech input and speech correction would use the same input channel, which may cause more errors introduced once a templated instruction is recognized mistakenly or if the user uses a wrong template.

### BRIEF SUMMARY OF THE DISCLOSURE

The present disclosure provides a method for speech recognition dictation and correction, and a related system. The present disclosure is directed to solve at least some of the problems and difficulties set forth above.

One aspect of the present disclosure provides a method for speech recognition dictation and correction, in which a speech recognition result is corrected through speech interaction between human and electronic devices based on a manner similar to the way of interpreting and understanding human natural languages.

The present disclosure provides the method implemented in a system including a terminal and a server, which may include transforming a speech signal received by the terminal into a speech recognition result. The transformation may be performed by an Automatic Speech Recognition (ASR) module, which can be constructed at the terminal or the sever. The method may further include determining a speech setting according to the speech recognition result. In response to an explicit command setting in which the speech recognition result contains a trigger word, the method may further include decomposing the speech recognition result into the trigger word and a command; modifying a first speech recognition result to form an edited speech recognition input according to the command; and displaying the edited speech recognition input on a user interface of the terminal.

The present disclosure also provides another embodiment of the method. The method implemented in a system including a terminal and a server, which may include: transforming a speech signal received by the terminal into a speech recognition result; determining the speech setting according to the speech recognition result. And an explicit command setting may be identified if the speech recognition result begins with a trigger word, and a pending setting may be identified if the speech recognition result does not begin with the trigger word. And in response to the explicit command setting, the speech recognition result may be decomposed into the trigger word and a command. And the command is analyzed to obtain a first match value If the first match value is greater than or equal to a first threshold, an operator and at least one target are obtained. A first speech recognition result is modified to form an edited speech recognition input according to the operator and the at least one target. The edited speech recognition input is displayed on a user interface of the terminal. And if the first match value is less than the first threshold, a user is prompted to re-input. In response to the pending setting, the speech recognition result is analyzed to obtain a second match value and a third match value. If the second match value is greater than or equal to a second threshold, and the third match value is less than a third threshold, a correct content and an error content are modified. The first speech recognition result is modified to form the edited speech recognition input according to the correct content and the error content. The edited speech recognition input is displayed on the user interface of the terminal. And if the second match value is less than the second threshold, and the third match value is greater than or equal to the third threshold, the speech recognition result is displayed on the user interface.

Another aspect of the present disclosure provides a system implementing embodiments of the present disclosure. Based on the disclosed method for speech recognition dictation and correction, the speech correction can be performed simply by speech interaction. Through the introduction of the NLU module, the templates required for correction in the conventional skills may be omitted.

### BRIEF DESCRIPTION OF THE DRAWINGS

To more clearly describe the technical solutions in the present disclosure or in the existing technologies, drawings accompanying the description of the embodiments or the existing technologies are briefly described below. Apparently, the drawings described below only show some embodiments of the disclosure. For those skilled in the art, other drawings may be obtained based on these drawings without creative efforts.

FIG. 1 illustrates a flow diagram of a method for speech recognition dictation and correction according to one embodiment of the present disclosure;

FIGS. 2a to 2c illustrate an exemplary user interface of a terminal in a sequence of operations according to one embodiment of the present disclosure;

FIG. 3 illustrates a flow diagram of forming an edited speech recognition input according to an analysis of a command consistent with the present disclosure;

FIG. 4 illustrates a data structure of a speech recognition result containing a trigger word consistent with the present disclosure;

FIG. 5a illustrates a flow diagram of a method for speech recognition dictation and correction according to one embodiment of the present disclosure;

FIG. 5b illustrates a flow diagram of forming an edited speech recognition input in an implicit command setting according to one embodiment of the present disclosure;

FIGS. 6a to 6c illustrates an exemplary user interface of a terminal in a sequence of operations according to another embodiment of the present disclosure;

FIGS. 7a to 7c illustrates an exemplary user interface of a terminal in a sequence of operations according to still another embodiment of the present disclosure;

FIG. 8 illustrates an exemplary system which implements embodiments of the disclosed method for speech recognition dictation and correction;

FIG. 9 is a schematic diagram of an exemplary hardware structure of a terminal according to one embodiment of the present disclosure;

FIG. 10 is a schematic diagram of an exemplary hardware structure of a Natural Language Understanding (NLU) module.

### DETAILED DESCRIPTION

Reference will now be made in detail to exemplary embodiments of the present disclosure, which are illustrated in the accompanying drawings. Wherever possible, the same reference numbers will be used throughout the drawings to refer to the same or like parts. It is apparent that the described embodiments are some but not all of the embodiments of the present disclosure. Based on the disclosed embodiments, persons of ordinary skill in the art may derive other embodiments consistent with the present disclosure, all of which are within the scope of the present disclosure.

Unless otherwise defined, the terminology used herein to describe the present disclosure is for the purpose of describing particular embodiments only and is not intended to limit the present disclosure. As used herein, the term “and/or” includes any and all combinations of one or more of the associated listed items. The terms of “first”, “second”, “third” and the like in the specification, claims, and drawings of the present disclosure are used to distinguish different elements and not to describe a particular order.

The present disclosure provides a method in which speech recognition dictation and correction is implemented based on a manner similar to the way of interpreting and understanding human natural languages. Embodiments of the present disclosure may be implemented as software applications installed on various devices, such as laptop computers, smartphones, smart appliances, etc. Embodiments of the present disclosure may help a user enter input more accurately and efficiently by providing multiple ways of editing and correcting speech recognition results.

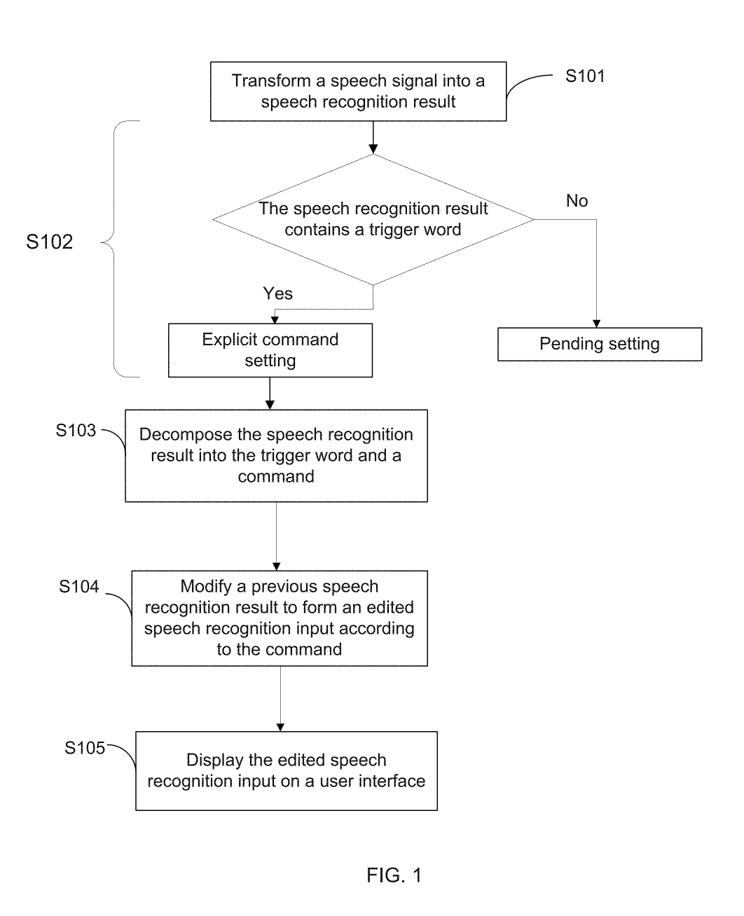

FIG. 1 illustrates a flow diagram of a method for speech recognition dictation and correction according to one embodiment of the present disclosure. As shown in FIG. 1, the method may include the following steps.

Step S101: The method may include transforming a speech signal received by a terminal into a speech recognition result.

The disclosed speech recognition dictation and correction method may be implemented in an environment which may include a terminal and a system, each including at least one processor respectively. That is, the method may be implemented in a speech recognition dictation and correction system. A user may input the speech signal at the terminal. The speech signal is received by the processor of the terminal, transmitted to an automatic speech recognition (ASR) module, and processed by the ASR module to transform the speech signal into the speech recognition result. The terminal herein may refer to any electronic device which requires speech recognition and is accordingly configured to receive and process speech signal inputs. For example, the terminal may include a mobile phone, a notebook, a desktop computer, a tablet, or the like. The automatic speech recognition (ASR) module, as the name suggests, is configured to perform speech recognition based on speech signals, and transform the received speech signals into the speech recognition results, preferably, in text format.

In one instance, the terminal may be equipped with the ASR module locally. Accordingly, the processor of the terminal may include the ASR module having an application-specific integrated chip (ASIC) for performing the speech recognition. In another example, however, the ASR module may be stored on a server. After the terminal receives the speech signals, it would transmit the speech signals to the server with the ASR module for data processing. Upon completion of the process, the speech recognition result may be generated, transmitted by the service, and then received by the processor of the terminal.

Step S102: The speech recognition dictation and correction system may determine a speech setting according to the speech recognition result. An explicit command setting may be identified if the speech recognition result contains a trigger word; and a pending setting may be identified if the speech recognition result does not contain the trigger word.

Depending on the obtained speech recognition result returned from the ASR module, the speech setting is accordingly determined. Similarly, this determining operation may be performed by the terminal locally or using the server. The speech setting may be identified based on whether the speech recognition result returned in text form contains the trigger word. In consideration of efficiency, in another instance, the speech setting may be identified based on whether the speech recognition result begins with the trigger word. Under this scenario, only the beginning portion of the speech recognition result may be inspected to determine whether the speech recognition result contains the trigger word.

As illustrated in FIG. 1, after step S102, if the speech recognition result contains the trigger word, the speech recognition dictation and correction system may identify that it is in the “explicit command setting”. On the other hand, if the speech recognition result does not contain the trigger word, the speech recognition dictation and correction system may identify that it is in the “pending setting”. “Explicit command setting” herein may indicate a scenario where the user intends to correct a previous speech recognition result, rather than a direct speech recognition output. By contrast, “pending setting” may indicate that the user may merely require a direct speech recognition output. As such, in response to the “pending setting,” the speech recognition result may be outputted on a user interface of the terminal following the previous speech recognition result. In some embodiments, however, the “pending setting” may also indicate that the user's intention cannot be determined at this point, and the system needs further operations to determine a setting. The details of the “pending setting” will be discussed and explained in the following.

The term trigger word herein may refer to words or phrases defined by the user or by the system as requirements for triggering at least one next operation. For example, “Kika” may be defined as a trigger word. As a result, the speech recognition result containing “Kika”, such as “Kika, replace saying with seeing”, will be accordingly identified as setting the system to the explicit command setting.

Step S103: In response to the explicit command setting, the speech recognition dictation and correction system may decompose the speech recognition result into the trigger word and a command.

If the speech recognition result contains the trigger word, the system for speech recognition dictation and correction may determine that it is in the explicit command setting at the first stage. That is, it is a scenario where the speech signal is inputted by the user to correct a previous speech recognition result. In response to the explicit command setting, by extracting the trigger word out of the speech recognition result, the system for speech recognition dictation and correction may obtain a command for speech recognition dictation and correction.

Using the speech recognition result of “Kika, replace saying with seeing” as an example, by extracting the predefined trigger word “Kika” out of the speech recognition result, the command of “replace saying with seeing” is accordingly obtained. Under some circumstances, the commands that the user gives may not be as clearly and simply interpreted as the above example. Details of these cases will be explained and analyzed in the following paragraphs.

Step S104: The system for speech recognition dictation and correction may modify a previous speech recognition result to form an edited speech recognition input according to the command.

Now that the trigger word is found, the user's intention to correct a previous speech recognition result is confirmed. Accordingly, the previous speech recognition result is modified to form an edited speech recognition input according to the obtained command. This modifying operation may be done by the processor of the terminal locally as soon as the command is obtained, or it may be completed by the server.

Step S105: The system for speech recognition dictation and correction may display the edited speech recognition input on a user interface of the terminal.

After the previous speech recognition result is modified and corrected to form the edited speech recognition input according to the command, the edited speech recognition input is accordingly shown on the user interface of the terminal. In one example, to avoid a possible error, the system may be configured to confirm, in voice, in text, or in a combination of both, with the user whether the correction is what the user intends for.

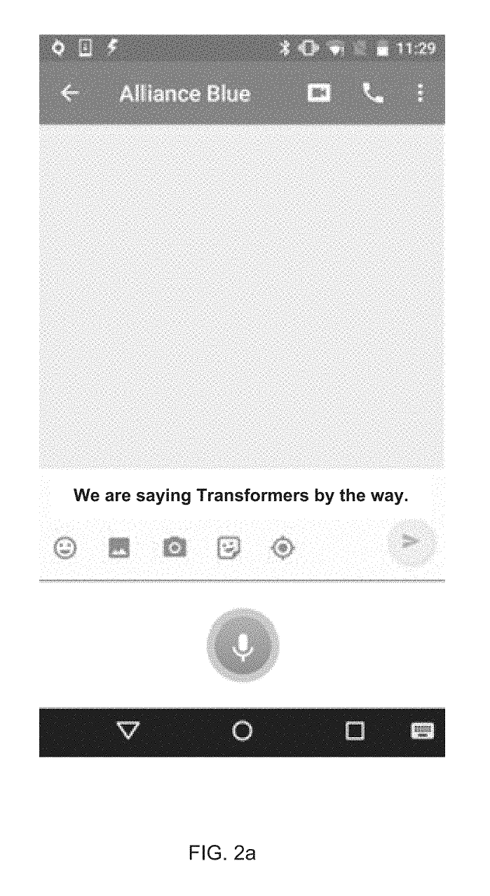

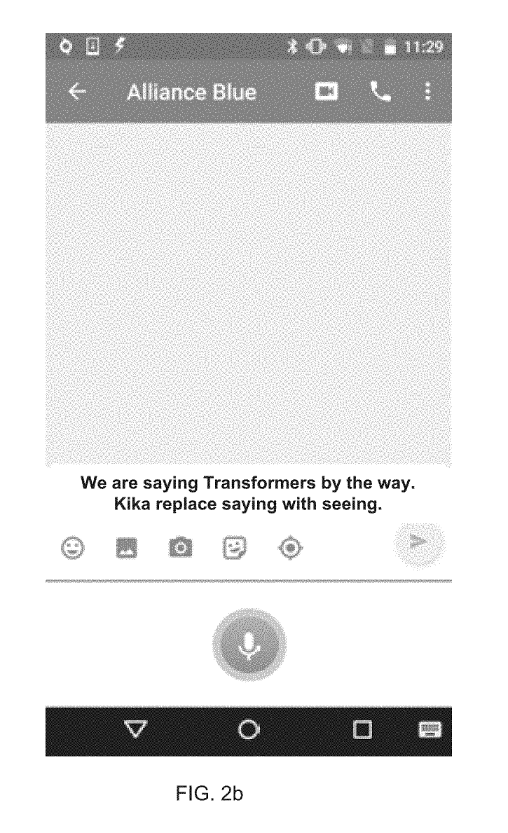

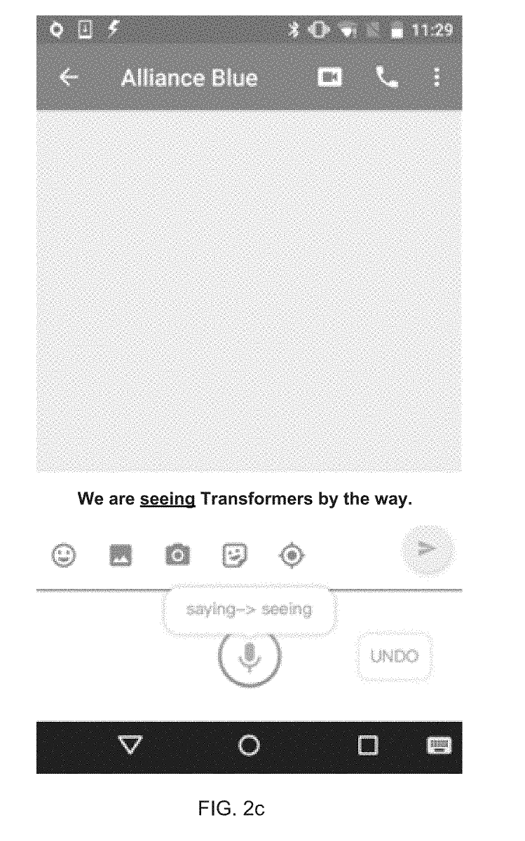

FIGS. 2a to 2b illustrate an exemplary user interface of a terminal in a sequence of operations according to one embodiment of the present disclosure. As illustrated in FIG. 2a, the speech recognition function of the terminal is activated by the user. In one embodiment, for ease of use, the user interface may include a click button for the user to trigger the speech recognition function. The first speech recognition result of “We are saying Transformers by the way” is obtained based on a speech signal inputted by the user and shown on the user interface. Afterwards, the user realizes that the first speech recognition result is incorrect. He/she then activates the speech recognition function again. As shown in FIG. 2b, the second speech signal of “Kika, replace saying with seeing” is given, in which “Kika” is the trigger word as pre-specified. The ASR module, either at the terminal or at the server, processes the second speech signal and generates the second speech recognition result. In one embodiment, the second speech recognition result is also shown on the user interface together with the first speech recognition result as illustrated in FIG. 2b. As such, it can facilitate the user to read and confirm his/her intended correction.

Now that the system detects the second speech recognition result contains the trigger word of “Kika”, an explicit command setting is identified. The second speech recognition result is then decomposed into the trigger word of “kika” and the command of “replace saying with seeing”. And the previous speech recognition result is modified according to the command of “replace saying with seeing”. As a result, the corrected speech recognition is shown in FIG. 2c as “We are seeing Transformer by the way.” In one instance, the user interface may emphasize the correction on the previous speech recognition result, such as underlining the correction of “seeing” as shown in FIG. 2c, and/or provide an undo button for the user to undo the correction.

In one aspect, the present disclosure provides the method for speech recognition dictation and correction, and the speech recognition dictation and correction system implementing the method. The system may include a Natural Language Understanding (NLU) module to analyze the command in a manner similar to the way of interpreting and understanding human natural languages. Natural Language Understanding (NLU) is an artificial intelligence technology to teach and enable a machine to learn, understand, and further remember human languages so as to enable a machine to conduct a direct communication with humans.

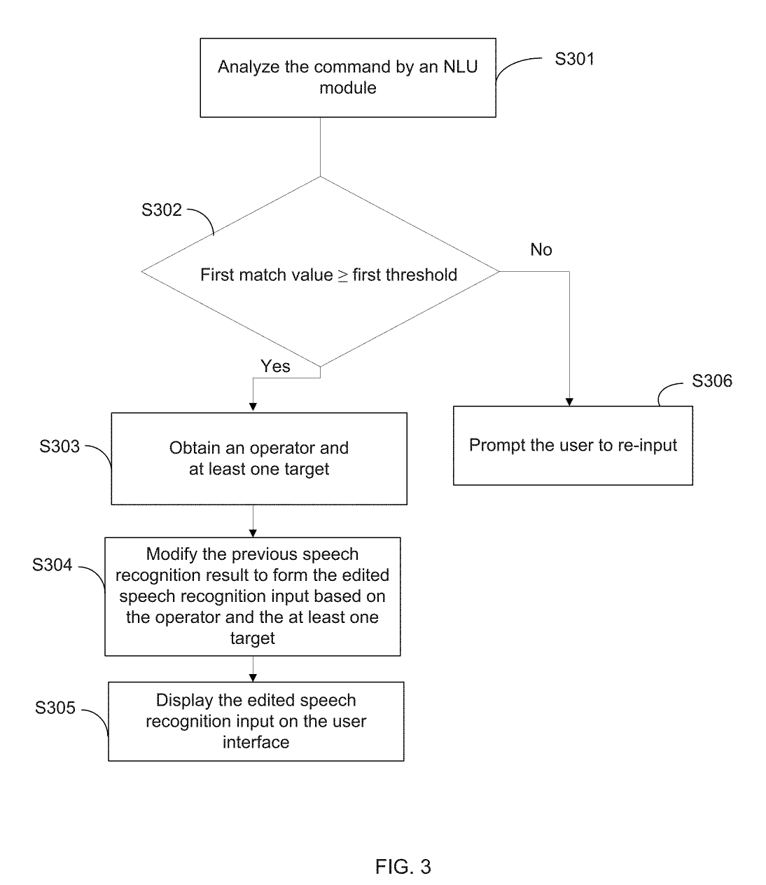

FIG. 3 illustrates a flow diagram of forming the edited speech recognition input according to the command consistent with the present disclosure. After the step of decomposing the speech recognition result into the trigger word and the command in step S103, the speech recognition dictation and correction system may further execute a step of analyzing the command by the NLU module as step S301 in FIG. 3. In response to the explicit command setting, the NLU module is configured to analyze the command extracted from the speech recognition result. In some implementations, the NLU module may include a knowledge database and a history database. The knowledge database is configured to provide stored analytical models for an input to match with, and, if an analytical result is found, the speech recognition dictation and correction system may output the result. On the other hand, the history database is configured to store historical data, based on which the analytical models of the knowledge database may be established and expanded. The historical data herein may include previous data analyses.

The NLU module may be implemented at the server or at the terminal. In some embodiments, the NLU module may conduct the analysis of the command based on the analytical models of the knowledge database established at the sever. In other embodiments, the NLU module may also perform an off-line analysis based on the analytical models and/or the algorithms generated locally. The analytical models may be established in a manner such that the NLU module analyzes the command in a manner similar to the way of interpreting and understanding human languages, not restricted to certain templates. The NLU module may be configured to merely perform step S301. Alternatively, the NLU module may also be configured to perform both of steps S103 and S301 in a sequence, meaning that the NLU module decomposes the speech recognition result and, afterwards, analyzes the command.

Once the NLU module obtains the command, the command is compared and matched with the analytical models by the NLU module to obtain a first match value. In a case where the first match value is greater than or equal to a first threshold as preset (step S302), it indicates that a match is found. In that case, an operator and at least one target can be successfully generated accordingly (step S303). In some embodiments, the operations the NLU module applies to conduct analyses on a command may include sentence segmentation, tokenization, lemmatization, parsing, and/or the like. The term “operator” herein may refer to certain operations that the user intends to perform on the previous speech recognition result for the correction. As an example, the operator may include “undo”, “delete”, “insert”, “replace”, or the like. Further, the term of “target” may refer to a content, or a location the operator works on. The target may include a deleted content, an inserted content, a replaced content, a replacing content, a null, or the like.

After obtaining the operator and the at least one target (step S303), the speech recognition dictation and correction system modifies the previous speech recognition result to form the edited speech recognition input based on the operator and the at least one target (step S304). And the edited speech recognition input is then displayed on the user interface (step S305).

Based on the example of FIGS. 2a to 2c, the NLU module generates an operator of “replace”, a target of “saying” as a replaced content, and the other target of “seeing” as a replacing content. Based on the operator and the targets, “saying” at “We are saying Transformers by the way” is replaced by “seeing” and the edited speech recognition input of “We are seeing Transformers by the way” is formed. As a result, the edited speech recognition input is displayed on the user interface as shown in FIG. 2c.

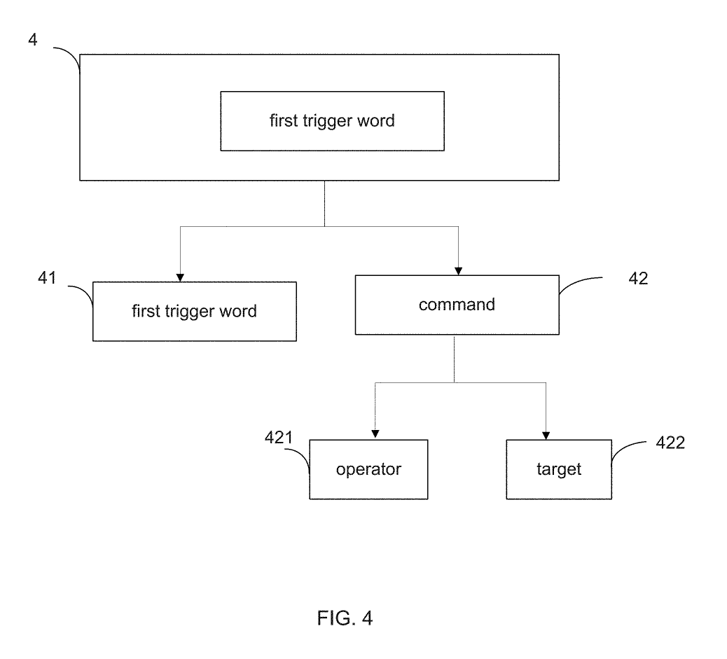

FIG. 4 illustrates a data structure of a speech recognition result containing a trigger word consistent with the present disclosure. The speech recognition result 4 is obtained and transformed based on the speech signal received by the terminal. In the explicit command setting, it implies that the speech recognition result 4 includes the trigger word 41 and the command 42 (extracting the trigger word out of the speech recognition result), and the command 42 is processed by the NLU module. In a successful case that a match is found, an operator 421 and at least one target 422 are obtained from the command 42.

Turning back to FIG. 3, step S306 shows a scenario where the first match value is less than the first threshold as preset. That is, a match cannot be found. This case is categorized as an exception, in which the explicit command setting is identified but the NLU module cannot correctly or clearly analyze and interpret the command so that the operator and the at least one target are found to modify the previous speech recognition result. In this case, the system may be configured to prompt the user to re-input. In one example, the user may be further informed of some correction examples for help. And the terminal may further include a speaker, and the manners of prompting the user may include a notification message in voice form through the speaker, in text form through the user interface, or in a combination of both.

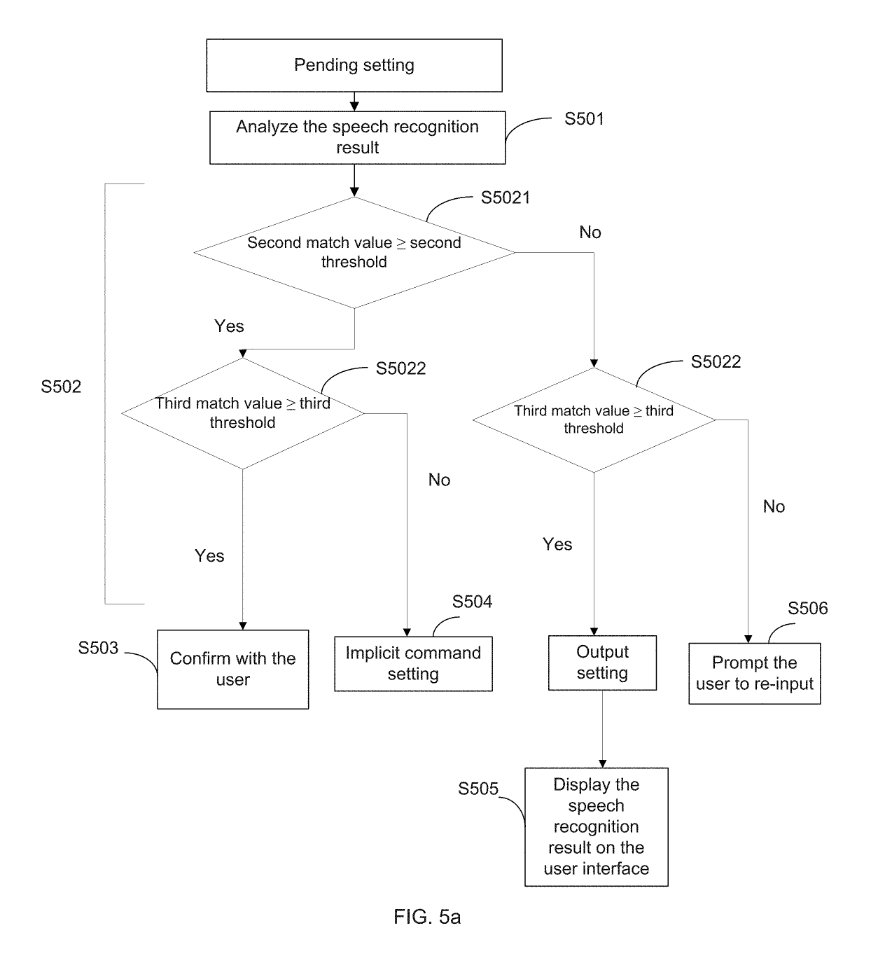

FIG. 5a illustrates a flow diagram of a method for speech recognition dictation and correction according to one embodiment of the present disclosure. In FIG. 1, the speech recognition result is inspected to determine whether it contains the trigger word. If the speech recognition result does not contain the trigger word, the pending setting is identified. As stated earlier, in some embodiments, for a pending setting, the speech recognition result may be directly outputted on the user interface following the previous speech recognition result. In some embodiments, however, the system may further analyze the speech recognition result for a pending setting as shown in FIG. 5a.

As depicted, for the pending setting, the speech recognition result is analyzed as step S501 of FIG. 5. In step S502, the NLU module further compares and matches the speech recognition result with the stored analytical models and/or algorithms to obtain a second match value based on whether a correct content or error content is found. The second match value may be regarded as a correction match value which indicates the user's intention level for correction. Meanwhile, a third match value may also be obtained, by analyzing the speech recognition result, to determine the user's intention level for a direct dictation. And the third match value may be regarded as a dictation match value. Accordingly, by comparing the second match value with a preset second threshold (S5021) and comparing the third match value with a preset third threshold (S5022), the second match value and the third match value collaborate to determine four scenarios as shown in Table 1, in which corresponding steps in FIG. 5a are also shown. It should be noted that the order of the comparison of the second match value with the second threshold, and the comparison of the third match value with the third threshold are not limited to the disclosed examples.

TABLE 1

| | | Second match |
|---|---|---|
| Correction | Second match value ≥ second | value < second |
| Dictation | threshold | threshold |
| Third match | Both intentions for correction | Intention for dictation |
| value ≥ third | and dictation | →output setting (S505) |
| threshold | →confirm with the user | |
| | (S503) | |
| Third match | Intention for correction | No intention |
| value < third | →implicit command setting | →prompt the user to |
| threshold | (S504) | re-input (S506) |

In a scenario where the second match value is greater than or equal to the second threshold as preset (intention for correction), and the third match value is also greater than or equal to the third threshold as preset (intention for dictation), now that the two match values indicate both intentions for correction and dictation, the system may be configured to confirm with the user (step S503) what he/she intends to do. In the second scenario where the second match value is still greater than or equal to the second threshold (intention for correction), but the third match value is less than the third threshold, the system can determine that it is in the implicit command setting (step S504), which implies a correct content and an error content can be successfully obtained. “Implicit command setting” herein is in contrast with “explicit command setting” set forth above, indicating that the user does not explicitly use the trigger word to conduct a correction on the speech recognition result, but still has the intention for correction.

If the second match value is less than the second threshold, there are the other two cases involve. For the first case, if the third match value is greater than or equal to the third threshold (intention for dictation), the system determines it is an output setting (step S505). Accordingly, the speech recognition result is displayed on the user interface. For the last case, if the third match value is less than the third threshold, the system cannot determine the user's intention and accordingly may be configured to prompt the user to re-input (step S506). In some embodiments, the steps S503 and S506 may refer to an identical step merely to prompt the user to re-input.

FIG. 5b illustrates a flow diagram of forming an edited speech recognition input in the implicit command setting according to one embodiment of the present disclosure. For the implicit command setting, a correct content and an error content are obtained (step S507) to modify the previous speech recognition result. Regarding the correct content and the error content in the implicit command setting, the situations that the system determines whether the speech recognition result contains the correct content and the error content may include the models described as follows.

Model I: The correct content is provided together with the error content in the speech signal.

Taking FIGS. 2a to 2c as an example, the previous speech recognition result is “We are saying Transformers by the way” as shown in FIG. 2a. After the user realizes this is not what he/she meant, and instead gives the second speech signal of “It's not saying, it's seeing”. In another example, the previous speech recognition result shows “Let's meet at 9 pm tonight”. The user may attempt to correct the error by giving a second speech signal of “Oops not 9 pm. It's 7 pm”.

In handling the Model I cases of step S507, the NLU module may be configured to apply a step similar to step S303 of FIG. 3 to analyze the speech recognition result, and extract the correct content and the error content out. Now that, in the Model I cases, the speech recognition result for correction contains both the correct content and the error content, by analyzing the speech recognition result with the previous speech recognition result, the correct content and the error content can be both obtained accordingly. In the first given example, the NLU is configured to analyze the speech recognition result to obtain the correct content of “seeing”, and the error content of “saying”. In the second example, similarly, the correct content of “7 pm”, and the error content of “9 pm” are decomposed.

Model II: The correct content is provided without an explicit error content in the speech signal.

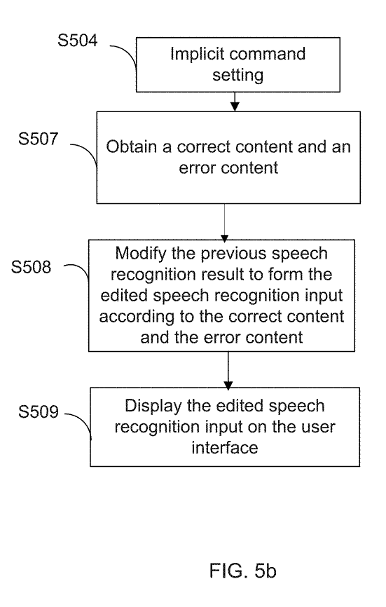

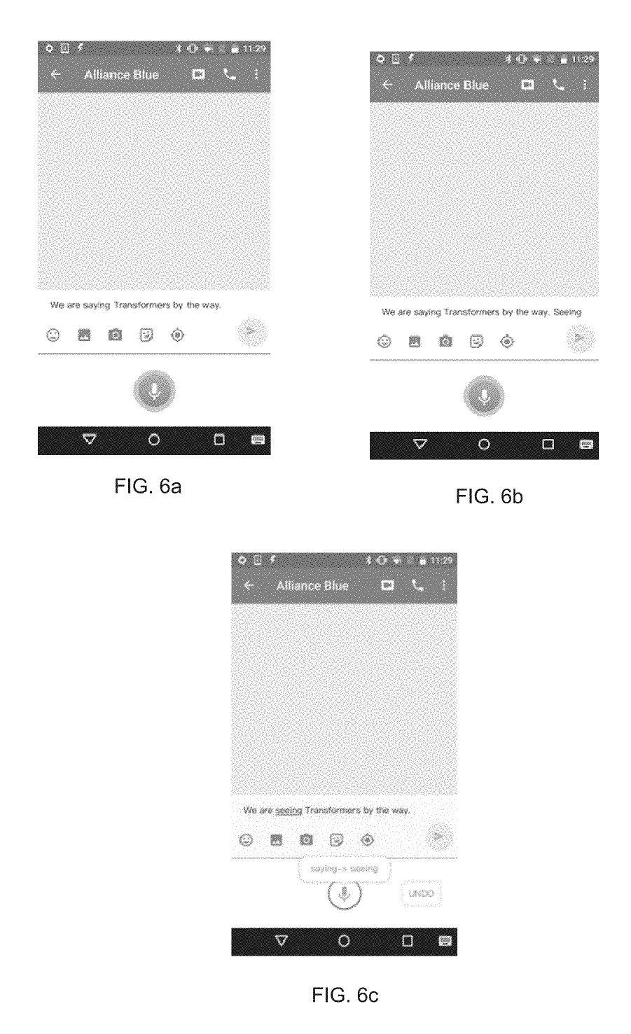

In FIGS. 2a to 2c, the previous speech recognition result given is “We are saying Transformers by the way” as shown in FIG. 2a. In one occasion, the user may attempt to correct the mistake by giving a second speech signal of “I said seeing” which only contains the correct content of “seeing”, FIGS. 6a to 6c show an exemplary user interface of a terminal in a sequence of operations according to another embodiment of the present disclosure and give another example. Alternatively, as shown in FIG. 6b, the user may conduct the correction simply by saying the correct content of “seeing” again.

In handling Model II cases of step S507, the NLU module is configured to compare the current speech recognition result with the previous speech recognition result to obtain the correct content. If the current speech recognition result does not contain the error content, the NLU module can locate a possible error content in the previous speech recognition result based on the analytical models, algorithms and the comparison with the previous speech recognition result.

Further, the previous speech recognition result is modified to form the edited speech recognition input according to the obtained correct content and the error content (step S508 in FIG. 5b), and the edited speech recognition input is thus shown on the user interface of the terminal (step S509 in FIG. 5b).

Turning back to step S503 of FIG. 5a, if the second match value is greater than or equal to the second threshold, and the third match value is also greater than or equal to the third threshold, the speech recognition dictation and correction system may execute the step S503. It indicates an ambiguous situation that the system is not certain about whether the user intends for a direct speech recognition output, or a correction on the previous speech recognition result. In order to prevent an operation with error, the system may be configured to send a confirmation message to the user to confirm his/her intention for correction. If the user confirms that a correction is intended, the system may be configured to request the user for re-input, and/or analyze the speech recognition result again. On the other hand, if the user requests for a direct speech recognition output, the current speech recognition result is shown following the previous speech recognition result. In a case where the user does not make any response or give any instruction to the system for the confirmation, the system may be configured to delete the current speech recognition result and perform no further operation.

In step S506, the case may be regarded as an exception, in which the system cannot determine the user's intention. Accordingly, the system may be configured to prompt the user to re-input. In one example, the user may be further informed of some correction examples for help. And the terminal may further include a speaker, and the manners of prompting the user may include a notification message in voice form through the speaker, in text form through the user interface, or in a combination of both.

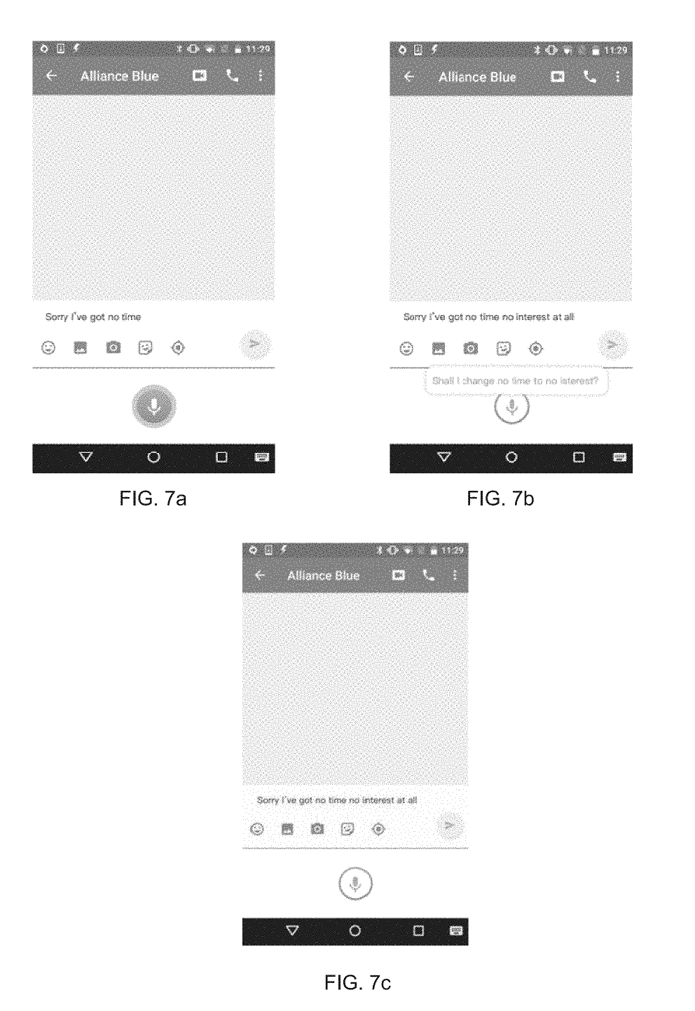

FIGS. 7a to 7c illustrate an exemplary user interface of a terminal in a sequence of operations according to still another embodiment of the present disclosure. In FIG. 7a, the previous speech recognition result of “Sorry I've got no time” is shown. And the system may be configured to retrieve the previous speech recognition result, and the second speech recognition result of “no interest at all” is displayed after the previous speech recognition result as shown in FIG. 7b. Based on the second match value as obtained, the system is confused about whether the current speech recognition of “no interest at all” is for correction or merely for a direct speech recognition output. In order to prevent a possible error, the system may be configured to prompt the user of a notification message either in voice or in text, such as “Shall I change no time to no interest?” as shown in FIG. 7b and wait for the user's confirmation. In implementations, the system may show button options on the user interface for the user to select for correction and/or for confirmation, or the system may activate the speech recognition function in order to receive the user's voice confirmation. In FIG. 7c, the user responds to the system that the current speech recognition result is merely for dictation output.

If the second match value is less than the second threshold, and the third match value is greater than or equal to the third threshold, the system eventually ensures that the user merely intends to perform a speech dictation. Accordingly, in step S505 of FIG. 5a, the speech recognition result is displayed on the user interface.

Based on the disclosed method for speech recognition dictation and correction, a speech correction may be performed simply by speech interaction. Through the introduction of the Natural Language Understanding (NLU) module, the system templates that may be required for making corrections in other systems may be omitted.

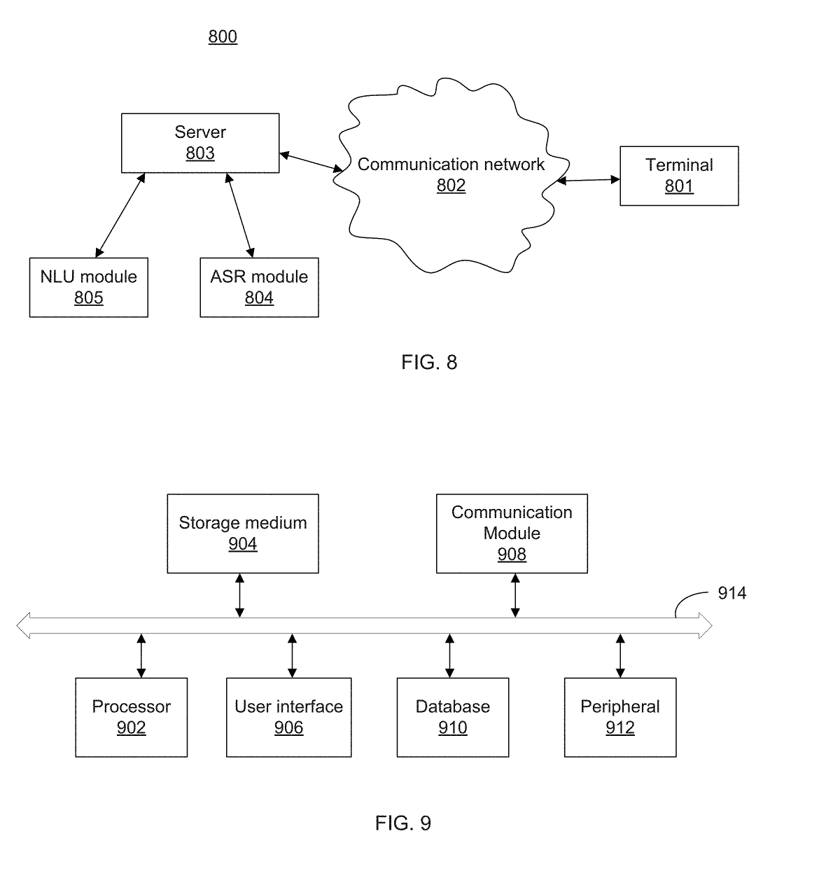

FIG. 8 illustrates an exemplary system which implements embodiments of the disclosed method for speech recognition dictation and correction. As shown in FIG. 8, the system 800 may include a terminal 801 and a server 803 in communication with the terminal 801 via a communication network 802. In some embodiments, the server 803 may include an ASR module 804 for transforming speech signals into speech recognition results, and an NLU module 805 for analyzing commands and/or speech recognition results for further operations. However, in some embodiments, the ASR module 804 and/or the NLU module may be implemented at the terminal 801.

FIG. 9 is a schematic diagram of an exemplary hardware structure of a terminal according to one embodiment of the present disclosure. The server 803 of the system may be implemented in a similar manner.

The terminal 801 in FIG. 9 may include a processor 902, a storage medium 904 coupled to the processor 902 for storing computer program instructions to be executed to realize the claimed method, a user interface 906, a communication module 908, a database 910, a peripheral 912, and a communication bus 914. When the computer program instructions stored in the storage medium are executed, the processor 902 of the terminal is configured to receive a speech signal from the user, and to instruct the communication module 908 to transmit the speech signal to the ASR module 804 via a communication bus 914. In one embodiment as shown in FIG. 8, the ASR module 804 of the server 803 is configured to process and transform the speech signal into a speech recognition result, preferably in text form. The terminal 801 obtains the speech recognition result returned from the server 803. Meanwhile, the NLU module 805 of the server 803 is configured to determine the speech setting according to the speech recognition result. As shown in FIG. 1, if the speech recognition result contains a trigger word as pre-specified, the explicit command setting is identified. But if the speech recognition result does not contain the trigger word, the speech recognition dictation and correction system decides that it is in a pending setting.

In some embodiments, in response to the explicit command setting where the user intends to correct the previous speech recognition result, the NLU module 805 of the server 803 is configured to analyze the speech recognition result and modify the previous speech recognition result into an edited speech recognition input. Accordingly, the edited speech recognition input after correction is shown on the user interface 906 of the terminal 801. In one instance, in response to the pending setting where the speech recognition output is intended, the processor 902 of the terminal 801 may be configured to show the speech recognition result on the display unit 906. In another instance, in response to the pending setting, the speech recognition result is further analyzed by the NLU module 805 to determine an appropriate setting for further operations.

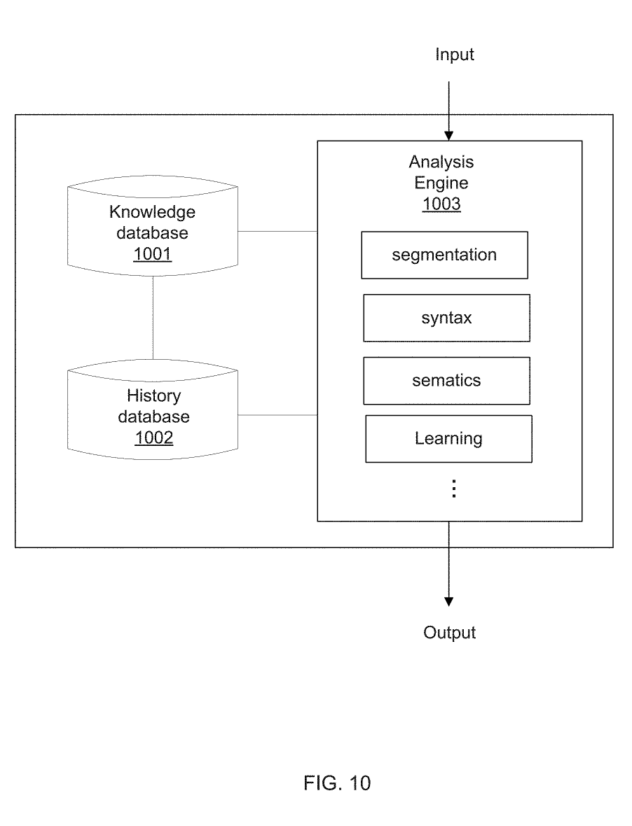

FIG. 10 is a schematic diagram of an exemplary hardware structure of a Natural Language Understanding (NLU) module. As shown in FIG. 10, in some embodiments, the NLU module may include a knowledge database 1001, a history database 1002, and an analysis engine 1003. As stated above, the knowledge database 1001 may be configured to provide stored analytical models, and the analysis engine 1003 may be configured to match an input with the stored analytical models. If an analytical result is found, the analysis engine 1003 may output the result. The history database 1002 may be configured to store historical data, based on which the analysis engine 1003 may build and expand the analytical models of the knowledge database 1001. The historical data herein may include previous data analyses.

Further as shown in FIG. 10, the analysis engine 1003 may include a plurality of function units. In some embodiments, the function unit may include a segmentation unit, a syntax analysis unit, a semantics analysis unit, a learning unit, and the like. The analysis engine 1003 may include a processor, and the processor may include, for example, a general-purpose microprocessor, an instruction-set processor and/or an associated chipset and/or a special purpose microprocessor (e.g., an application specific integrated circuit (ASIC)), and the like.

In those function units of the analysis engine 1003, the segmentation unit may be configured to decompose a sentence input into a plurality of words or phrases. The syntax unit may be configured to determine properties of each element, such as subject, object, verb and the like, in the sentence input by algorithms. The semantics unit may be configured to predict and interpret a correct meaning of the sentence input through the analyses of the syntax unit. And the learning unit may be configured to train a final model based on the historical analyses.

The specific principles and implementation manners of the system provided in the embodiments of the present disclosure are similar to those in the foregoing embodiments of the disclosed method and are not described herein again.

In some embodiments of the present disclosure, the integrated unit implemented in the form of a software functional unit may be stored in a computer-readable storage medium. The software function unit may be stored in a storage medium and includes several instructions for enabling a computer device (which may be a personal computer, a server, a network device, etc.) or a processor to execute some steps of the method according to each embodiment of the present disclosure. The foregoing storage medium includes a medium capable of storing program code, such as a USB flash disk, a removable hard disk, a read-only memory (ROM), a random access memory (RAM), a magnetic disk, an optical disc, or the like.

Those skilled in the art may clearly understand that the division of the foregoing functional modules is only used as an example for convenience. In practical applications, however, the above function allocation may be performed by different functional modules according to actual needs. That is, the internal structure of the device is divided into different functional modules to accomplish all or part of the functions described above. For the working process of the foregoing apparatus, reference may be made to the corresponding process in the foregoing method embodiments, and details are not described herein again.

It should be also noted that the foregoing embodiments are merely intended for describing the technical solutions of the present disclosure, but not to limit the present disclosure. Although the present disclosure is described in detail with reference to the foregoing embodiments, it should be understood by those of ordinary skill in the art that the technical solutions described in the foregoing embodiments may still be modified, or a part or all of the technical features may be equivalently replaced without departing from the spirit and scope of the present disclosure. As a result, these modifications or replacements do not make the essence of the corresponding technical solutions depart from the scope of the technical solutions of the present disclosure.

Other embodiments of the disclosure will he apparent to those skilled in the art from consideration of the specification and practice of the disclosure provided herein. It is intended that the specification and examples be considered as exemplary only, with a true scope and spirit of the disclosure being indicated by the claims as follows.

What is claimed is:

1. A method for speech recognition dictation and correction, comprising:
transforming a speech signal received by a terminal into a speech recognition result;
determining a speech setting according to the speech recognition result, wherein in response to an explicit command setting in which the speech recognition result contains a trigger word:
decomposing the speech recognition result into the trigger word and a command;
modifying a first speech recognition result to form an edited speech recognition input according to the command; and
displaying the edited speech recognition input on a user interface of the terminal.

2. The method according to claim 1, in response to the explicit command setting, further comprising:
obtaining an operator and at least one target; and
modifying the first speech recognition result to form the edited speech recognition input according to the operator and the at least one target.

3. The method according to claim 1, further comprising:
obtaining a first match value; and
prompting a user to re-input if the first match value is less than a first threshold.

4. The method according to claim 3, wherein the prompting the user to re-input comprises a notification message in voice form, a notification message in text form, or a notification message in a combination thereof.

5. The method according to claim 1, in response to a pending setting in which the speech recognition result does not contain the trigger word, the method further comprising:
obtaining a second match value;
if the second match value is greater than or equal to a second threshold: obtaining a correct content and an error content; modifying the first speech recognition result to form the edited speech recognition input according to the correct content and the error content; and displaying the edited speech recognition input on the user interface of the terminal; and
if the second match value is less than the second threshold: displaying the speech recognition result on the user interface of the terminal.

6. The method according to claim 5, prior to displaying the speech recognition result on the user interface of the terminal, further comprising: sending a confirmation message to the user.

7. The method according to claim 6, further comprising: if no instruction is received from the user, deleting the speech recognition result from the user interface of the terminal.

8. The method according to claim 6, further comprising: if an instruction is received from the user for conducting a correction on the first speech recognition result, deleting the speech recognition result on the user interface of the terminal, and prompting the user to re-input.

9. The method according to claim 5, prior to displaying the speech recognition result on the user interface of the terminal, further comprising:
displaying the first speech recognition result; and
displaying the speech recognition result following the first speech recognition result.

10. The method according to claim 1, wherein: the explicit command setting is identified if the speech recognition result begins with the trigger word.

11. The method according to claim 1, further comprising: sending the speech signal to the server by the terminal; and transforming, by an Automatic Speech Recognition (ASR) module of the server, the speech signal into the speech recognition result.

12. A method for speech recognition dictation and correction implemented in a system including a terminal and a server, comprising:
transforming a speech signal received by the terminal into a speech recognition result;
determining a speech setting according to the speech recognition result, wherein: an explicit command setting is identified if the speech recognition result begins with a trigger word, and a pending setting is identified if the speech recognition result does not begin with the trigger word; and
in response to the explicit command setting:
decomposing the speech recognition result into the trigger word and a command;
analyzing the command to obtain a first match value;
if the first match value is greater than or equal to a first threshold: obtaining an operator and at least one target; modifying a first speech recognition result to form an edited speech recognition input according to the operator and the at least one target; and displaying the edited speech recognition input on a user interface of the terminal; and
if the first match value is less than the first threshold, prompting a user to re-input; and
in response to the pending setting:
analyzing the speech recognition result to obtain a second match value and a third match value;
if the second match value is greater than or equal to a second threshold, and the third match value is less than a third threshold: obtaining a correct content and an error content; modifying the first speech recognition result to form the edited speech recognition input according to the correct content and the error content; and
displaying the edited speech recognition input on the user interface of the terminal;
if the second match value is greater than or equal to the second threshold, and the third match value is greater than or equal to the third threshold: sending a confirmation message to the user;
if the second match value is less than the second threshold, and the third match value is greater than or equal to the third threshold: displaying the speech recognition result on the user interface; and
if the second match value is less than the second threshold, and the third match value is less than the third threshold: prompting the user to re-input.

13. The method according to claim 12, wherein the prompting the user to re-input comprises a notification message in voice form, a notification message in text form, or a notification message in a combination thereof.

14. The method according to claim 12, prior to displaying the speech recognition result on the user interface of the terminal, further comprising:
displaying the first speech recognition result; and
displaying the speech recognition result following the first speech recognition result.

15. A system of speech recognition dictation and correction, comprising:
a server including a Natural Language Understanding (NLU) module;
a terminal including a processor, a user interface coupled to the processor, and a storage medium for storing computer program instructions, when executed, that cause the processor to:
obtain a speech recognition result based on a speech signal; and
determine a speech setting according to the speech recognition result, wherein: an explicit command setting is identified if the speech recognition result begins with a trigger word, and a pending setting is identified if the speech recognition result does not begin with the trigger word;
in response to the explicit command setting,
the server is configured to decompose the speech recognition result into the trigger word and a command;
the NLU module is configured to modify a first speech recognition result to form an edited speech recognition input according to the command; and the processor of the terminal is configured to display the edited speech recognition input on the user interface; and
in response to the pending setting:
the NLU module is configured to analyze the speech recognition result to obtain a second match value and a third match value;
if the second match value is greater than or equal to a second threshold, and the third match value is less than a third threshold: the NLU module is further configured to obtain contents, and modify the first speech recognition result to form the edited speech recognition input according to the contents; and the processor of the terminal is configured to display the edited speech recognition input on the user interface of the terminal;
if the second match value is greater than or equal to the second threshold, and the third match value is greater than or equal to the third threshold: the processor of the terminal is configured to send a confirmation message to the user;
if the second match value is less than the second threshold, and the third match value is greater than or equal to the third threshold: the processor of the terminal is configured to display the speech recognition result on the user interface; and
if the second match value is less than the second threshold, and the third match value is less than the third threshold: the processor of the terminal is configured to prompt the user to re-input.

16. The system according to claim 15, wherein the NLU module comprises:
a knowledge database for storing analytical models;
an analysis engine configured to match the speech recognition result with the analytical models and obtain the first match value and the second match value; and
a history database for storing historical data on which the analysis engine establishes and expands the analytical models of the knowledge database.

17. The system according to claim 15, wherein: the processor of the terminal is configured to display the first speech recognition result on the user interface and display the speech recognition result following the first speech recognition result on the user interface.

18. The system according to claim 15, wherein the processor of the terminal is configured to prompt the user to re-input by a notification message shown on the user interface.

19. The system according to claim 15, wherein the terminal further comprises a speaker, and the processor of the terminal is configured to prompt the user to re-input by a voice notification message through the speaker.

20. The system according to claim 15, wherein the server includes an Automatic Speech Recognition (ASR) module, and the processor of the terminal is configured to send the speech signal to the ASR module, and the ASR module is configured to transform the speech signal into the second speech recognition result.
